(19) United States
(12) Patent Application Publication
(10) Pub. No.: US 2016/0026588 A1
(43) Pub. Date: Jan. 28, 2016

(54) SYSTEM AND METHOD FOR BUS WIDTH CONVERSION IN A SYSTEM ON A CHIP

(71) Applicant: QUALCOMM INCORPORATED, San Diego, CA (US)

(72) Inventors: Jeffrey Hao CHU, San Diego, CA (US); Neil Evan CHRISTANTO, San Diego, CA (US)

(21) Appl. No.: 14/339,017

(22) Filed: Jul. 23, 2014

(51) Int. Cl. G06F 13/40; G06F 13/28; G06F 13/42

(52) U.S. Cl. CPC G06F 13/4018; G06F 13/4221; G06F 13/28

(57) ABSTRACT

Various embodiments of methods and systems for precompensated bus width conversion (“PBWC”) in a portable computing device (“PCD”) are disclosed. Because starting memory addresses for data transfers emanating from a processing engine in a system on a chip (“SoC”) may be misaligned with a starting memory address of a main bus on the SoC, PBWC solutions seek to precompensate data transfers to align the starting addresses. Advantageously, by doing so PBWC embodiments may significantly reduce the amount of “filler” data chunks that are transferred through the main bus, thereby optimizing band width utilization of the main bus.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices. PCDs commonly contain integrated circuits, or systems on a chip (“SoC”), that include numerous components designed to work together to deliver functionality to a user. For example, a SoC may contain any number of processing engines such as modems, central processing units (“CPUs”) made up of cores, graphical processing units (“GPUs”), etc. that read and write data and instructions to and from memory components on the SoC. The data and instructions are transmitted between the devices via a collection of wires known as a bus.

A bus may include two parts in the forms of an address bus and a data bus; the data bus being used to actually transfer data and instructions between the processing engines and the memory components, and the address bus being used to specify a physical address within a memory component from which data or instructions are read, or to which data or instructions are written.

When designing a processing engine, designers determine that the engine transmits and receives data according to a certain bus width, i.e. via a certain chunk size and at a certain rate. For example, a given processing engine may be designed to transmit data in 16-byte chunks, or 32-byte chunks, or 64-byte chunks or whatever chunk size deemed necessary by its designers. Because a SoC may contain any number of processing engines designed for communicating via different bus widths, it is often necessary for data transmissions emanating from certain processing engines to undergo a bus width conversion that conditions the data for transmission on a larger bus than the native bus for which the processing engine was originally designed.

Notably, when there is a difference in widths between a processing engine's native bus and the larger SoC bus, a starting memory address dictated by the native bus may not be aligned with the starting memory address of the larger bus on which the data must travel. To accommodate the address misalignment, bus width conversion methods known in the art often transmit “filler data” to fill unused address locations created by the misalignment. The transmission of the filler data reduces the overall efficiency of data transfer on the SoC bus as bus width capacity is wasted by transmitting the filler data.

Therefore, there is a need in the art for a system and method that minimizes the need to transmit filler data when the starting address dictated by a native bus of a processing engine is misaligned with the starting address of a larger bus on the SoC through which a data transfer must travel. More specifically, there is a need in the art for a system and method that pre-compensates a data transfer such that starting memory addresses are aligned prior to a bus width conversion.

### SUMMARY OF THE DISCLOSURE

Various embodiments of methods and systems for precompensated bus width conversion (“PBWC”) in a portable computing device (“PCD”) are disclosed. Because starting memory addresses for data transfers emanating from a processing engine in a system on a chip (“SoC”) may be misaligned with a starting memory address of a main bus on the SoC, PBWC solutions seek to precompensate data transfers to align the starting addresses. Advantageously, by doing so PBWC embodiments may significantly reduce the amount of filler data chunks that are transferred through the main bus, thereby optimizing band width utilization of the main bus.

One exemplary PBWC method includes a band width conversion (“BWC”) manager receiving a data transfer request from a processing engine that is associated with a native bus having a bus width that is less than a bus width of a main bus. As would be understood by one of ordinary skill in the art, the data transfer request may be a series of data bursts each comprised of a plurality of data chunks. The BWC manager may then determine that a native bus starting memory address for the data transfer is misaligned with a main bus starting memory address. In response to the misalignment, the BWC manager may precompensate the data transfer by aligning the native bus starting memory address with the main bus starting memory address before performing a bus width conversion of the data transfer to transmit the data transfer through the main bus.

The exemplary PBWC method may precompensate the data transfer by disassociating a first data chunk from a first data burst of the series of data bursts and before performing a bus width conversion of the data transfer to transmit the data transfer through the main bus by implementing a first transaction on the main bus of the disassociated first data chunk and a filler data chunk. Advantageously, by sending the disassociated first data chunk in a separate transaction, along with a filler data chunk to fill out the addresses on a bus cycle of the main bus, the PBWC method ensures that the address of the second data chunk of the original first data burst will become the new first data chunk of a rebuilt first data burst and be aligned with the main bus address. To complete the rebuilt first data burst, the PBWC method may disassociate a first data chunk from an original second data burst of the series of data bursts and associate it with the data chunks remaining from the original first data burst. The PBWC method may continue precompensating each data burst in the data transfer series by breaking up the data bursts and rebuilding them such that the last data chunk of a given data burst is the first disassociated data chunk from a subsequent data burst in the data transfer series. In this way, a PBWC embodiment may mitigate the need to use filler data chunks to fill out unused addresses at the beginning and ending of a transaction that result from a bus width conversion where the starting addresses of the native bus of a processing component and the larger main bus of the SoC are misaligned.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 illustrates a series of data transfers via a bus width conversion when the starting addresses of the native bus and the larger bus are aligned versus when the starting addresses of the native bus and the larger bus are misaligned;

FIG. 2 illustrates a series of data transfers via a bus width conversion when the starting addresses of the native bus and the larger bus are misaligned and the data transfer is precompensated according to an embodiment of a precompensated bus width conversion (“PBWC”) solution;

FIG. 3 is a functional block diagram illustrating an exemplary, non-limiting aspect of a portable computing device (“PCD”) in the form of a wireless telephone for implementing precompensated bus width conversion (“PBWC”) methods and systems;

FIG. 4 is a functional block diagram illustrating an embodiment of an on-chip system for executing precompensated bus width conversions of data transfers from processing engines to a double data rate (“DDR”) memory;

FIG. 5 is a schematic diagram illustrating an exemplary software architecture of the PCD of FIG. 3 for precompensated bus width conversion (“PBWC”); and

FIG. 6 is a logical flowchart illustrating a method for executing precompensated bus width conversions of data transfers from processing engines to a memory component.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference to “DDR” memory components will be understood to envision any of a broader class of volatile random access memory (“RAM”) and will not limit the scope of the solutions disclosed herein to a specific type or generation of RAM. That is, it will be understood that various embodiments of the systems and methods provide a solution for bus width conversion of precompensated data transfers forming all or part of read and/or write transaction requests to a memory component defined by pages/rows of memory banks and are not necessarily limited in application to double data rate memory. Moreover, it is envisioned that certain embodiments of the solutions disclosed herein may be applicable to DDR, DDR-2, DDR-3, low power DDR (“LPDDR”) or any subsequent generation of RAM. As would be understood by one of ordinary skill in the art, DDR RAM is organized in rows or memory pages of discrete “odd” and “even” memory addresses and, as such, the terms “row” and “memory page” are used interchangeably in the present description. The memory pages of DDR may be divided into four sections, called banks in the present description. Each bank may have a register associated with it and, as such, one of ordinary skill in the art will recognize that in order to address a row of DDR (i.e., a memory page), an address of both a memory bank and a row may be required. A memory bank may be active, in which case there may be one or more open pages associated with the register of the memory bank.

In this description, the term “contiguous” is used to refer to data blocks stored in a common memory page of a DDR memory and, as such, is not meant to limit the application of solutions to reading and/or writing data blocks that are stored in an uninterrupted series of “odd” and “even” addresses on a memory page. For example, although an embodiment of the solution may read or write data blocks from/to addresses in a memory page numbered sequentially 2, 3 and 4, an embodiment may also read or write data blocks from/to addresses in a memory page numbered 2, 5, 12 without departing from the scope of the solution.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or chip may be comprised of one or more distinct processing components generally referred to herein as “core(s).”

In this description, the terms “engine,” “processing engine” and the like are used to refer to any component within a system on a chip (“SoC”) that transfers data over a bus to or from a memory component. As such, a processing engine may refer to, but is not limited to refer to, a CPU, DSP, GPU, modem, controller, etc.

In this description, the term “bus” refers to a collection of wires through which data is transmitted from a processing engine to a memory component or other device located on or off the SoC. It will be understood that a bus consists of two parts—an address bus and a data bus where the data bus transfers actual data and the address bus transfers information specifying location of the data in a memory component. The term “width” or “bus width” refers to an amount of data, i.e. a “chunk size,” that may be transmitted per cycle through a given bus. For example, a 16-byte bus may transmit 16 bytes of data at a time, whereas 32-byte bus may transmit 32 bytes of data per cycle. Moreover, “bus speed” refers to the number of times a chunk of data may be transmitted through a given bus each second. Similarly, a “bus cycle” or “cycle” refers to transmission of one chunk of data through a given bus.

In this description, “native bus” and “source bus” are used interchangeably and refer to a bus and/or bus width associated with a certain processing engine. Data transfers are understood in this description to emanate from a processing engine associated with a “native bus” or “source bus” that may be of a lesser bus width than a “destination bus” or “main bus” or “SoC bus” that exists on the SoC for transmitting data to, from and between devices on the SoC (such as between a processing engine and a memory device). As such, the terms “destination bus,” “main bus,” “SoC bus” and the like are also used interchangeably.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

Various processing engines running simultaneously in a PCD to deliver functionality to a user may necessitate that a bus of the PCD's SoC have a width sized to accommodate a large volume of data traffic. Simply speaking, with increased ability to deliver functionality comes the need for a data highway that can accommodate peak demand on the SoC for data transfer. Notably, therefore, the SoC bus is often larger than the native bus size for which a given processing engine was originally designed.

The difference in bus widths between the native buses of certain processing engines and the larger bus on the SoC, which is sized to handle simultaneous data transfer loads coming from multiple processing engines, dictates that data transfers from certain processing engines must undergo a bus width conversion prior to being transmitted on the SoC bus. When the starting address determined by the address bus portion of the SoC bus is aligned with the starting address of the native bus associated with the certain processing engine, then the bus width conversion may be efficient.

When the starting addresses differ, however, the bus width conversion processes of known systems and methods may use filler data to “fill” the unused capacity that is caused by the misalignment in each bus cycle. For example, consider a 256-byte data transfer from a processing engine with a native bus size of 16 bytes undergoing 2x bus width conversion. After bus width conversion, the 256-byte data transfer should ideally take 8 cycles of 32-byte data chunks to complete when transmitted on a larger SoC bus with a 32-byte bus width. But, if the starting address of the native bus is misaligned with the starting address of the SoC bus (e.g., the starting address of the native bus is an “odd” memory address whereas the starting address of the SoC bus is an “even” memory address), the 256-byte data transfer will require two transactions—a first 256-byte transaction that includes filler data at its beginning to align the starting addresses and a second transaction which is the final 16 bytes of the data transfer plus 16 more bytes of filler data to fill out the 32-byte cycle. The 9 cycles to complete the 256-byte data transfer results in an effective capacity on the SoC bus of 28.4 bytes per cycle (256 bytes/9 cycles) instead of the more efficient 32 bytes per cycle of which the SoC bus is capable.

Advantageously, embodiments of precompensated bus width conversion solutions combat the degradation in effective bus capacity that results from misaligned starting addresses by breaking up the data transfer when the starting addresses are misaligned so that the starting address of the second transaction is aligned with the starting address of the larger SoC bus. In this way, each subsequent data burst may be converted for transmission on the larger SoC bus without the need to include filler data in an unused address. A more detailed explanation of exemplary embodiments of precompensated bus width conversion solutions will be described below with reference to the figures.

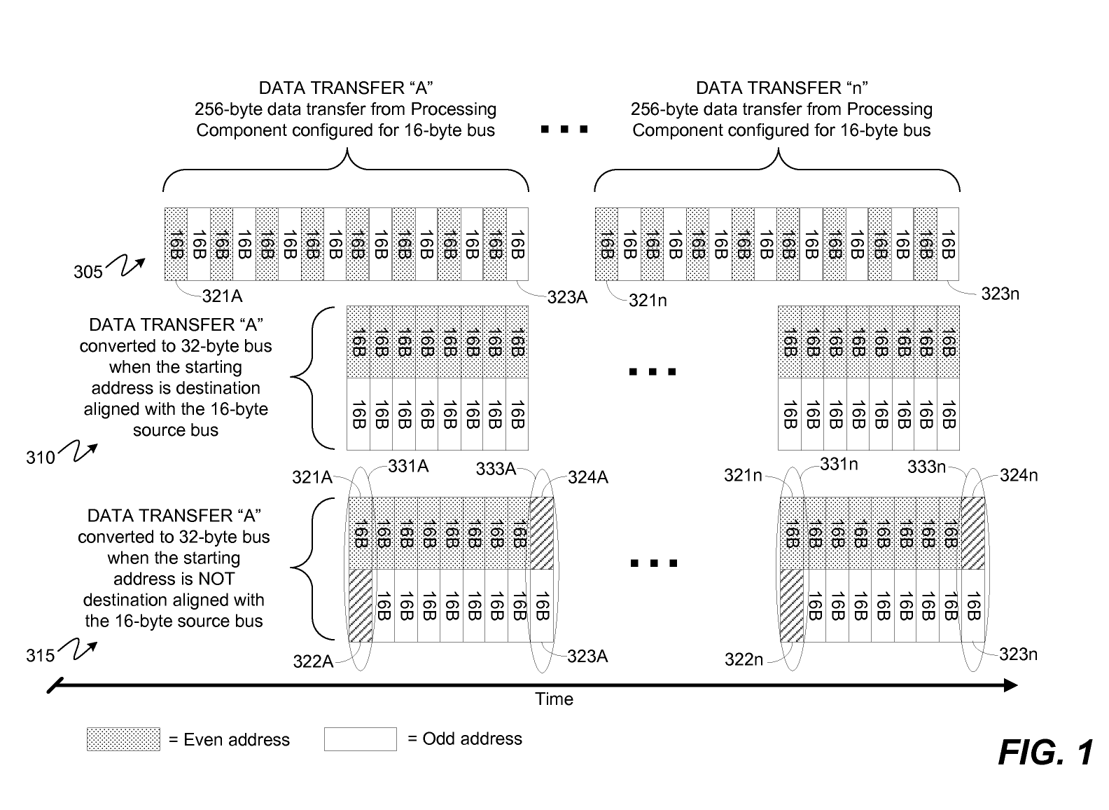

Turning to FIG. 1, illustrated is a series of data transfers 305 via a bus width conversion when the starting addresses of the native bus and the larger bus are aligned 310 versus when the starting addresses of the native bus and the larger bus are misaligned 315. The data transfer sizes are 256-bytes in length and made up of 16 chunks of 16-byte size each. Notably, the data transfer sizes are exemplary in nature; it is envisioned that embodiments of precompensated bus width conversion (“PBWC”) solutions may accommodate data transfers of sizes other than 256-bytes. As such, one of ordinary skill in the art will recognize that the particular data transfer sizes, chunk sizes, bus widths, etc. that are referred to in this description are offered for exemplary purposes only and do not limit the scope of the envisioned solutions as being applicable to applications having the same data transfer sizes, chunk sizes, bus widths, etc.

Returning to the FIG. 1 illustration, a series 305 of data transfers emanating from a processing engine are depicted. Data Transfer “A” is a 256-byte data transfer comprised of 16 data chunks of 16 bytes each. As described above, a data transfer such as Data Transfer “A” may be comprised of 16 data chunks of 16 bytes each by virtue of the processing engine from which it originates being designed to transmit data through a native bus with a 16-byte bus width. In the illustration, the series 305 of 256-byte data transfers emanates in a string of consecutive data transfers ending in Data Transfer n.

In the FIG. 1 illustration, the series 305 of 256-byte data transfers may undergo a bus width conversion for transmission across a larger SoC bus having a 32-byte bus width. With this in mind, series 310 represents the result of the series 305 of 256-byte data transfers once converted for transfer on the 32-byte SoC bus when the starting memory address dictated by the source bus is aligned with the starting address dictated by the larger SoC bus. As can be seen in the series 310, when the starting addresses of the source bus and SoC bus are aligned, eight 32-byte cycles complete the 256-byte data transfer.

Turning to the series 315, however, when the starting addresses of the source bus and SoC bus are misaligned, it takes an additional 32-byte cycle on the SoC bus to complete the 256-byte data transfer. In the FIG. 1 illustration, the source bus dictates that the starting address of the Data Transfer “A” is an “even” address, whereas the SoC bus dictates that the starting address of a data transfer must be an “odd” address. Due to the misalignment, current systems and methods for bus width conversion simply “fill” the starting “odd” address of the SoC bus with a chunk of filler data 322A so that the first real 16-byte data chunk 321A is transmitted in association with the “even” address of the first cycle 331A. As a result, an additional cycle 333A is required in order for the last “odd” 16-byte data chunk 323A of the Data Transfer “A” to be transmitted along with a second chunk of filler data 324A. Because the starting addresses remain misaligned for the transfer of Data Transfer “n,” the pattern repeats with filler data chunk 322n filling the “odd” address of cycle 321n and filler data chunk 324n filling the “even” address of the ninth cycle 333n. The result is a reduction in the effective bus capacity of the SoC bus from an ideal 32-byte width to a less efficient 28.4-byte width.

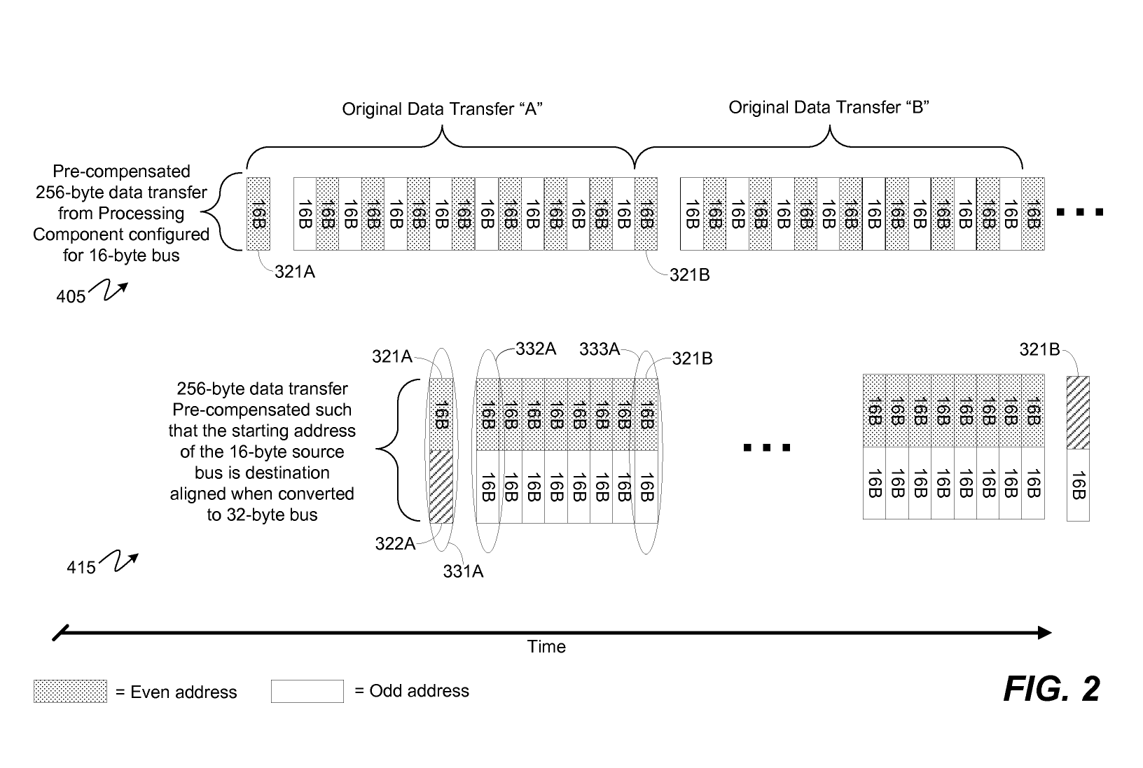

Turning now to the FIG. 2 illustration, illustrated is a series 405 of data transfers via a bus width conversion when the starting addresses of the native bus and the larger bus are misaligned and the data transfer is precompensated according to an embodiment of a precompensated bus width conversion (“PBWC”) solution. Embodiments of a PBWC solution may recognize that the starting addresses of the source bus and the destination bus (i.e., the SoC bus) are misaligned. For example, in the FIG. 2 illustration the first chunk 321 of Data Transfer “A” is associated with an “even” starting address while the starting address of the SoC bus is associated with an “odd” address. To accommodate the misalignment, a PBWC embodiment may break up the original Data Transfer “A” such that the first data chunk 321A is isolated and transmitted on the SoC bus as a single 32-byte transaction that includes the 16-byte data chunk 321A along with a filler data chunk 322A filling the “odd” starting address of cycle 331A.

Subsequently, a 256-byte data transfer is built by associating the first 16-byte data chunk 321B of original Data Transfer “B” with the fifteen remaining data chunks of original Data Transfer “A”. The next new data transfer is then built by associating 16-byte data chunk 321C (not shown) with the remaining fifteen 16-byte data chunks of original Data Transfer “B”. In this way, the starting addresses for each of the rebuilt 256-byte data transfers will be “odd” and align with the starting addresses of the exemplary 32-byte SoC bus illustrated by series 415. Advantageously, the exemplary PBWC solution described relative to the FIG. 2 illustration requires that only two filler data chunks 322A, 324n be transmitted in order for series 405 to be converted to series 415 for transmission across the larger SoC bus. In this way, embodiments of PBWC solutions optimize the capacity of a SoC bus when processing engines designed for smaller buses generate data transfers with starting addresses that are misaligned with the starting addresses of the SoC bus.

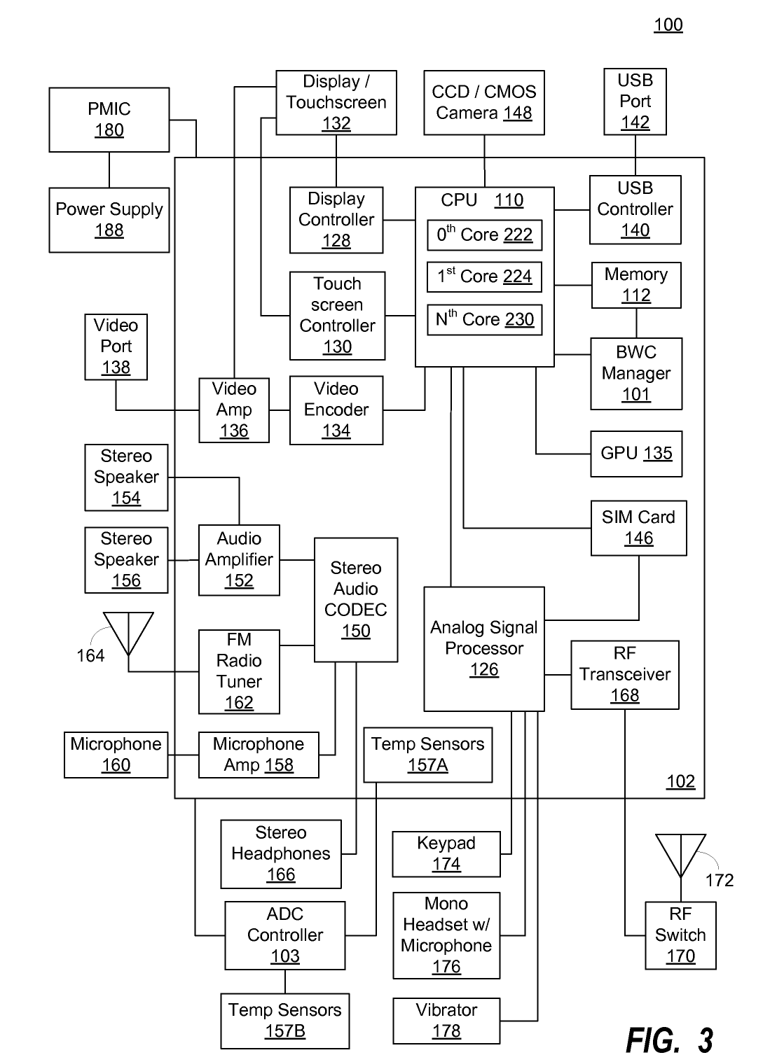

FIG. 3 is a functional block diagram illustrating an exemplary, non-limiting aspect of a portable computing device (“PCD”) 100 in the form of a wireless telephone for implementing precompensated bus width conversion (“PBWC”) methods and systems. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, bus width conversion (“BWC”) manager 101 may be formed from hardware and/or firmware and may be responsible for precompensating data transfers emanating from various devices on the chip 102 such that the starting addresses of the data transfers align with the starting addresses of a destination bus of the chip 102. It is envisioned that write bursts to a DDR memory 115 (generally labeled 112 in the FIG. 3 illustration), for instance, may be precompensated such that the starting addresses of bursts are aligned with starting addresses of a SoC bus without having to use filler data chunks to fill unused addresses on each transaction. By precompensating the data transfers when the starting addresses are not aligned with the main bus, filler data chunks are only transmitted on a first short transaction and a last short transaction on the main bus thereby optimizing band width utilization for data transactions between the first and last.

As illustrated in FIG. 3, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 3, a universal serial bus (“USB”) controller 140 is coupled to the CPU 110. Also, a USB port 142 is coupled to the USB controller 140. A memory 112, which may include a PoP memory, a cache 116, a mask ROM/Boot ROM, a boot OTP memory, a DDR memory 115 (see subsequent Figures) may also be coupled to the CPU 110. A subscriber identity module (“SIM”) card 146 may also be coupled to the CPU 110. Further, as shown in FIG. 3, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 3, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 3 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 3 further indicates that a radio frequency (“RF”) transceiver 168 may be coupled to the analog signal processor 126. An RF switch 170 may be coupled to the RF transceiver 168 and an RF antenna 172. As shown in FIG. 3, a keypad 174 may be coupled to the analog signal processor 126. Also, a mono headset with a microphone 176 may be coupled to the analog signal processor 126. Further, a vibrator device 178 may be coupled to the analog signal processor 126. FIG. 3 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 3 may reside on chip 102 in other exemplary embodiments.

In a particular aspect, one or more of the method steps described herein may be implemented by executable instructions and parameters stored in the memory 112 or as form the BWC manager 101. Further, the BWC manager 101, the memory 112, the instructions stored therein, or a combination thereof may serve as a means for performing one or more of the method steps described herein.

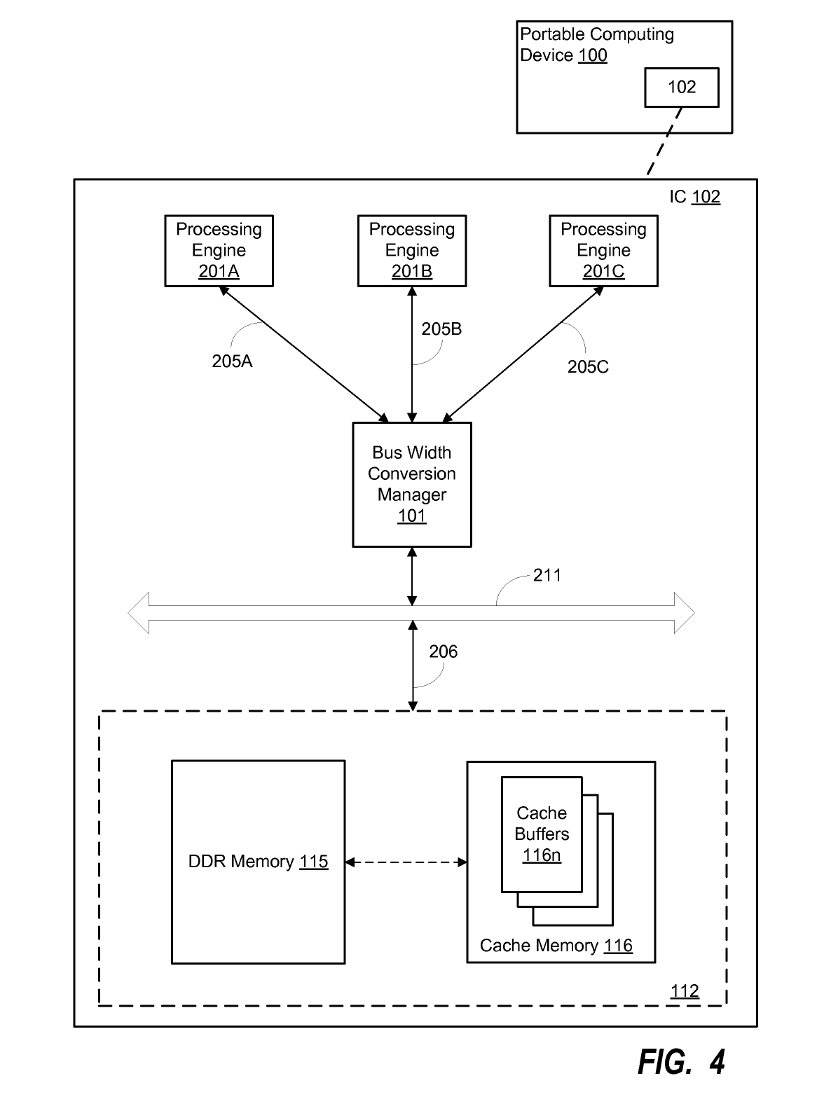

FIG. 4 is a functional block diagram illustrating an embodiment of an on-chip system 102 for executing precompensated bus width conversions of data transfers from processing engines 201 to a double data rate (“DDR”) memory 115. As indicated by the arrows 205 in the FIG. 4 illustration, a processing engine 201 may be submitting transaction requests for either reading data from the DDR 115 or writing data to the DDR 115, or a combination thereof, via a system bus 211. As is understood by one of ordinary skill in the art, a processing engine 201, such as the CPU 110, in executing a workload could be fetching and/or updating instructions and/or data that are stored at the address(es) of the DDR memory 115. Notably, the exemplary PBWC embodiment of FIG. 4 is described within the context of transmitting data to a DDR memory 115, however, this is for illustrative purposes only as one of ordinary skill in the art would recognize that PBWC embodiments may facilitate transfer of data from processing engines on a SoC via a main bus to any other device on the SoC and/or any other memory component type.

Returning to the FIG. 4 illustration, the arrows 205 also represent native bus widths associated with each of processing engines 201. The main SoC bus 211 may have been sized with a bus width that is larger than the native bus widths 205. As the processing engines 201 generate data transfers for transmission via bus 211 to cache memory 116 and/or DDR memory 115, the bus width conversion manager 101 may recognize that the starting address dictated by a native bus 205 is misaligned with a starting address dictated by the main bus 211. In response, the BWC manager 101 may precompensate for the misalignment by breaking up the data transfers and rebuilding them prior to bus width conversion such that the starting memory addresses are aligned. Once precompensated, the rebuilt data transfers may be converted via the BWC manager 101 for transmission to memory 112 iva bus 211 without requiring transmission of filler data chunks on each transaction. In this way, the average number of bus cycles required on bus 211 to transmit a series of data transfers having misaligned starting addresses may be optimized.

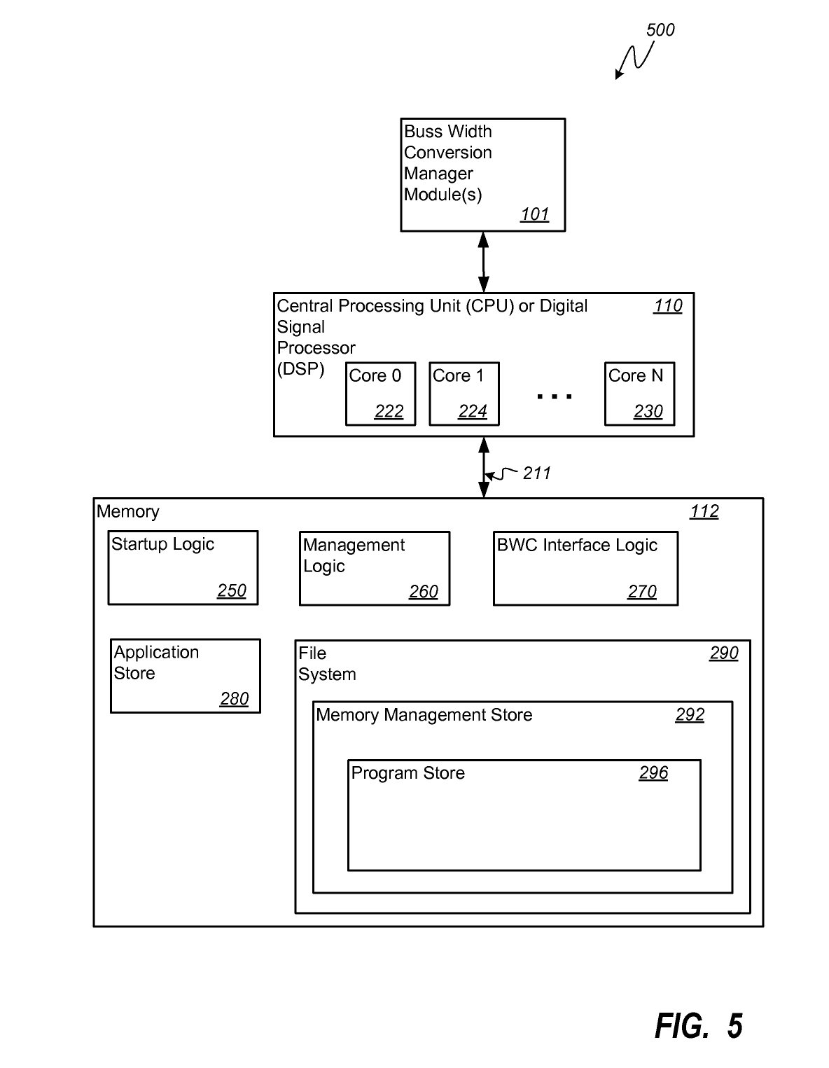

FIG. 5 is a schematic diagram 500 illustrating an exemplary software architecture of the PCD of FIG. 3 for precompensated bus width conversion (“PBWC”). As illustrated in FIG. 5, the CPU or digital signal processor 110 is coupled to the memory 112 via main bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores.

The CPU 110 may receive commands from the BWC manager module(s) 101 that may comprise software and/or hardware. If embodied as software, the module(s) 101 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art and described above in the definitions. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 5, it should be noted that one or more of startup logic 250, management logic 260, BWC interface logic 270, applications in application store 280 and portions of the file system 290 may be stored on any computer-readable medium for use by, or in connection with, any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the BWC interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 is a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for precompensating data transfers emanating from processing engines and requiring bus width conversion prior to transmission on bus 211. The startup logic 250 may identify, load and execute a select BWC program. An exemplary select program may be found in the program store 296 of the embedded file system 290. The exemplary select program, when executed by one or more of the core processors in the CPU 110 may operate in accordance with one or more signals provided by the BWC manager module 101 to precompensate data transfers prior to bus width conversion and transmission on bus 211.

The management logic 260 includes one or more executable instructions for terminating a bus width conversion management program on one or more of the respective processor cores, as well as selectively identifying, loading, and executing a more suitable replacement program. The management logic 260 is arranged to perform these functions at run time or while the PCD 100 is powered and in use by an operator of the device. A replacement program may be found in the program store 296 of the embedded file system 290.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the processing engines requiring precompensation of data transfers.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged memory management store 292. In this regard, the file system 290 may include a reserved section of its total file system capacity for the storage of information for the configuration and management of the various bus width conversion algorithms used by the PCD 100.

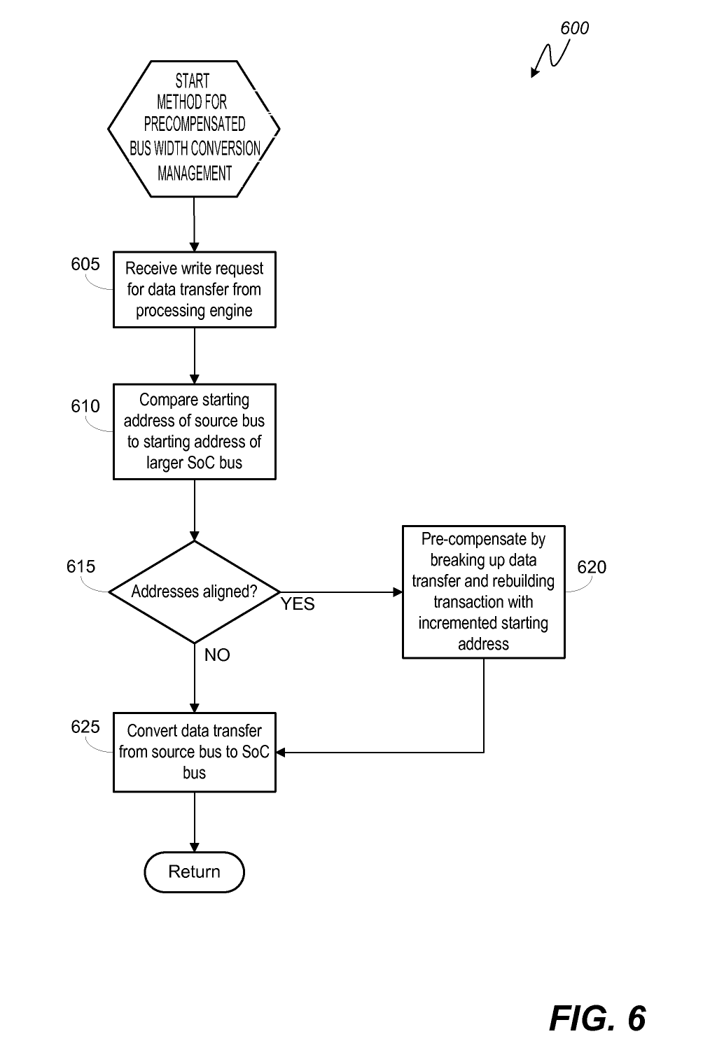

FIG. 6 is a logical flowchart illustrating a method 600 for executing precompensated bus width conversions of data transfers from processing engines to a memory component. Beginning at block 605, a data transfer such as may include write instructions and/or data may emanate from a processing engine and be received or recognized by a PBWC manager module 101. At block 610, the PBWC manager module 101 may compare the starting address dictated by a source bus associated with the design of the processing engine to the starting address required by the larger SoC bus.

At decision block 615, the PBWC manager module 101 may determine whether the starting address dictated by the source bus of the processing engine is misaligned with the starting address required by the main SoC bus. That is, if one of the starting addresses is an “odd” address while the other starting address is an “even” address, then the PBWC may recognize that the addresses are misaligned. If the addresses are aligned, then no precompensation is required and the “no” branch is followed to block 625. If, however, the starting addresses are misaligned, the method 600 follows the “yes” branch from decision block 615 to block 620. At block 620, the data transfer may be precompensated by the PBWC manager module 101 by breaking up the series of data transfers and rebuilding them such that the starting addresses of each full data transaction is aligned with the starting address required by the main SoC bus.

If no precompensation is required at decision block 615, or after precompensation at block 620, the method 600 proceeds to block 625 and the data transfer series is converted for transmission on the main SoC bus. The method 600 returns.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for compensating bus misalignment when undergoing bus width conversion in a system on a chip (“SoC”) in a portable computing device (“PCD”), the method comprising:
receiving a data transfer request from a processing engine, wherein:
the processing engine is associated with a native bus having a bus width that is less than a bus width of a main bus; and
the data transfer request is a series of data bursts each comprised of a plurality of data chunks;
determining that a native bus starting memory address for the data transfer is misaligned with a main bus starting memory address;
precompensating the data transfer by aligning the native bus starting memory address with the main bus starting memory address; and
performing a bus width conversion of the data transfer to transmit the data transfer through the main bus.

2. The method of claim 1, wherein:
precompensating the data transfer comprises disassociating a first data chunk from a first data burst of the series of data bursts; and
performing a bus width conversion of the data transfer to transmit the data transfer through the main bus comprises implementing a first transaction on the main bus of the disassociated first data chunk and a filler data chunk.

3. The method of claim 2, wherein:
precompensating the data transfer further comprises disassociating a first data chunk from a second data burst of the series of data bursts and rebuilding the first data burst into a rebuilt first data burst by associating the first data chunk from the second data burst with data chunks remaining in the first data burst; and
performing a bus width conversion of the data transfer to transmit the data transfer through the main bus further comprises implementing a second transaction on the main bus of the rebuilt first data burst.

4. The method of claim 3, wherein the rebuilt first data burst is absent any filler data chunks.

5. The method of claim 1, wherein the processing engine is selected from a group comprised of a central processing unit (“CPU”), graphical processing unit (“GPU”), camera and modem.

6. The method of claim 1, further comprising transmitting the data transfer through the main bus to a memory device.

7. The method of claim 1, wherein the memory device is a double data rate (“DDR”) memory device.

8. A system for compensating bus misalignment when undergoing bus width conversion in a system on a chip (“SoC”) in a portable computing device (“PCD”), the system comprising:
a bus width conversion (“BWC”) manager operable to:
receive a data transfer request from a processing engine, wherein:
the processing engine is associated with a native bus having a bus width that is less than a bus width of a main bus; and
the data transfer request is a series of data bursts each comprised of a plurality of data chunks;
determine that a native bus starting memory address for the data transfer is misaligned with a main bus starting memory address;
precompensate the data transfer by aligning the native bus starting memory address with the main bus starting memory address; and
perform a bus width conversion of the data transfer to transmit the data transfer through the main bus.

9. The system of claim 8, wherein the BWC manager is further operable to:
precompensate the data transfer by disassociating a first data chunk from a first data burst of the series of data bursts; and
perform a bus width conversion of the data transfer to transmit the data transfer through the main bus by implementing a first transaction on the main bus of the disassociated first data chunk and a filler data chunk.

10. The system of claim 9, wherein the BWC manager is further operable to:
precompensate the data transfer by disassociating a first data chunk from a second data burst of the series of data bursts and rebuilding the first data burst into a rebuilt first data burst by associating the first data chunk from the second data burst with data chunks remaining in the first data burst; and
perform a bus width conversion of the data transfer to transmit the data transfer through the main bus further by implementing a second transaction on the main bus of the rebuilt first data burst.

11. The system of claim 10, wherein the rebuilt first data burst is absent any filler data chunks.

12. The system of claim 8, wherein the processing engine is selected from a group comprised of a central processing unit (“CPU”), graphical processing unit (“GPU”), camera and modem.

13. The system of claim 8, wherein the BWC manager is further operable to transmit the data transfer through the main bus to a memory device.

14. The system of claim 8, wherein the memory device is a double data rate (“DDR”) memory device.

15. The system of claim 8, wherein the PCD is in the form of a wireless telephone.

16. A system for compensating bus misalignment when undergoing bus width conversion in a system on a chip (“SoC”) in a portable computing device (“PCD”), the system comprising:
means for receiving a data transfer request from a processing engine, wherein:
the processing engine is associated with a native bus having a bus width that is less than a bus width of a main bus; and
the data transfer request is a series of data bursts each comprised of a plurality of data chunks;
means for determining that a native bus starting memory address for the data transfer is misaligned with a main bus starting memory address;
means for precompensating the data transfer by aligning the native bus starting memory address with the main bus starting memory address; and
means for performing a bus width conversion of the data transfer to transmit the data transfer through the main bus.

17. The system of claim 16, wherein:
means for precompensating the data transfer comprises means for disassociating a first data chunk from a first data burst of the series of data bursts; and
means for performing a bus width conversion of the data transfer to transmit the data transfer through the main bus comprises means for implementing a first transaction on the main bus of the disassociated first data chunk and a filler data chunk.

18. The system of claim 17, wherein:
means for precompensating the data transfer further comprises means for disassociating a first data chunk from a second data burst of the series of data bursts and rebuilding the first data burst into a rebuilt first data burst by associating the first data chunk from the second data burst with data chunks remaining in the first data burst; and
means for performing a bus width conversion of the data transfer to transmit the data transfer through the main bus further comprises means for implementing a second transaction on the main bus of the rebuilt first data burst.

19. The system of claim 18, wherein the rebuilt first data burst is absent any filler data chunks.

20. The system of claim 16, wherein the processing engine is selected from a group comprised of a central processing unit (“CPU”), graphical processing unit (“GPU”), camera and modem.

21. The system of claim 16, further comprising means for transmitting the data transfer through the main bus to a memory device.

22. The system of claim 16, wherein the memory device is a double data rate (“DDR”) memory device.

23. The system of claim 16, wherein the PCD is in the form of a wireless telephone.

24. A computer program product comprising a computer usable medium having a computer readable program code embodied therein, said computer readable program code adapted to be executed to implement a method for compensating bus misalignment when undergoing bus width conversion in a system on a chip (“SoC”) in a portable computing device (“PCD”), said method comprising:
receiving a data transfer request from a processing engine, wherein:
the processing engine is associated with a native bus having a bus width that is less than a bus width of a main bus; and
the data transfer request is a series of data bursts each comprised of a plurality of data chunks;
determining that a native bus starting memory address for the data transfer is misaligned with a main bus starting memory address;
precompensating the data transfer by aligning the native bus starting memory address with the main bus starting memory address; and
performing a bus width conversion of the data transfer to transmit the data transfer through the main bus.

25. The computer program product of claim 24, wherein:
precompensating the data transfer comprises disassociating a first data chunk from a first data burst of the series of data bursts; and
performing a bus width conversion of the data transfer to transmit the data transfer through the main bus comprises implementing a first transaction on the main bus of the disassociated first data chunk and a filler data chunk.

26. The computer program product of claim 25, wherein:
precompensating the data transfer further comprises disassociating a first data chunk from a second data burst of the series of data bursts and rebuilding the first data burst into a rebuilt first data burst by associating the first data chunk from the second data burst with data chunks remaining in the first data burst; and
performing a bus width conversion of the data transfer to transmit the data transfer through the main bus further comprises implementing a second transaction on the main bus of the rebuilt first data burst.

27. The computer program product of claim 26, wherein the rebuilt first data burst is absent any filler data chunks.

28. The computer program product of claim 24, wherein the processing engine is selected from a group comprised of a central processing unit (“CPU”), graphical processing unit (“GPU”), camera and modem.

29. The computer program product of claim 24, further comprising transmitting the data transfer through the main bus to a memory device.

30. The computer program product of claim 24, wherein the memory device is a double data rate (“DDR”) memory device.
